(19) United States
(12) Patent Application Publication
(10) Pub. No.: US 2019/0372619 A1
(43) Pub. Date: Dec. 5, 2019

(54) POWER LINE COMMUNICATION ARCHITECTURE FOR INDOOR ENVIRONMENT

(71) Applicant: Lite Puter Enterprise Co., Ltd., New Taipei City (TW)

(72) Inventor: Kun-Pai HSU, Taipei City (TW)

(21) Appl. No.: 16/431,701

(22) Filed: Jun. 4, 2019

(30) Foreign Application Priority Data
Jun. 4, 2018 (CN) 201810564969.X

(51) Int. Cl. H04B 3/54; H04B 3/06

(52) U.S. Cl. CPC H04B 3/54; H04B 2203/5429; H04B 3/06

(57) ABSTRACT

A power line communication architecture for indoor environment having a power cable includes two filters, one of the filters disposed between the power cable and an indoor circuit and the other filter including an independent sub filter connected in series between an external device and the indoor circuit and an integrated sub filter disposed in an original device. The power line communication architecture further includes a signal coupling and isolation module, a signal receiving and transmitting module and a digital signal processing module. The signal coupling and isolation module loads a control signal into a power line or extracts the control signal from the power line. The signal receiving and transmitting module digitalizes an analog signal extracted from the power line by the signal coupling and isolation module. The digital signal processing module digitally processes and exchanges signals obtained from power lines for A and B phases.

### CROSS-REFERENCE TO RELATED PATENT APPLICATION

This application claims the benefit of priority to China Patent Application No. 201810564969.X, filed on Jun. 4, 2018 in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of power and communication line installation in intelligent buildings, and more particularly to power line communication architecture for indoor environment.

### BACKGROUND OF THE DISCLOSURE

Power line communication (PLC) refers to a technology that realizes data transmission and information exchange by using its own distribution network as a transmission medium. Currently, power line communication technologies generally include narrowband communication, orthogonal frequency division multiplexing (OFDM), spread spectrum communication, and other PLC technologies. However, the abovementioned conventional power line communication technologies usually have some problems. For example, as a cable has capacitive reactance and inductive reactance, the higher the frequency is, the greater the signal attenuation is. Moreover, since many power devices are provided on a power line, when the power devices are in operation, a deep fade in impedance characteristics would occur at the working frequency and the double frequency. The smaller the load impedance is, the greater the absorption of communication signals is, which is not conducive to communication signal transmission. Further, power lines are lines transmitting power, instead of dedicated lines. As a result, power line communication involves more complexity and uncertainty than dedicated lines. High power electrical devices, such as motors, generate many high-order harmonics in electrical grids. These high-order harmonics only exist at the frequencies which are integer multiples of the utility frequency. With large energy, the frequencies may extend to tens of thousands of Hertz. If signal frequencies overlap with them, the communication reliability may be greatly impacted. Lightning also generates high currents and high voltage pulses in power lines, with a peak current value of thousands of amperes and a voltage peak value of thousands of volts. Accordingly, the conventional power line communication technology is marginalized, losing the convenience.

Although China patent application no. 201610609849.8 discloses a “SMART LIGHT ILLUMINATION SYSTEM AND CONTROL METHOD THEREOF,” in the smart light illumination system, it still requires multiple devices to realize power line communication technology for indoor lighting devices and leaves room for improvement.

### SUMMARY OF THE DISCLOSURE

In response to the above-referenced technical inadequacies, the present disclosure provides power line communication architecture for indoor environment, which is suitable for a power environment such as household, office, hotel room electricity environments and is not easy to be interfered. In one aspect, the present disclosure provides power line communication architecture for indoor environment having a power cable. The power line communication architecture includes: two filters, a CPU, and a power source. One of the filters is disposed between the power cable and an indoor circuit, and the other filter includes an independent sub filter and an integrated sub filter. The independent sub filter is connected in series between an external device and the indoor circuit, and the integrated sub filter is disposed in an original device. The integrated sub filter separates power and signals and forms a signal channel and a power channel, the signal channel provides an access for a control signal to enter and exit, and the power channel provides power for a power supply and a load controlling output of the original device. The power channel blocks the control signal, and the signal channel blocks power so as to prevent the control signal from being attenuated due to an overload occurred in the original device. The power line communication architecture further includes two signal coupling and isolation modules, two signal receiving and transmitting modules, and a digital signal processing module. The signal coupling and isolation modules are used to load the control signal into the power line or extract the control signal from the power line, and isolate alternating current; the signal receiving and transmitting modules are used to digitalize an analog signal extracted from the power line by the signal coupling and isolation modules, or convert a digital signal to an analog signal to be loaded into the power line by the signal coupling and isolation modules; the digital signal processing module digitally processes and exchanges signals obtained from power lines for A and B phases.

Comparing with the conventional power line communication system and smart light illumination control system, with the abovementioned features the power line communication architecture of the present disclosure has advantages of convenient wiring and simple structure, without setting communication lines. Further, comparing with wireless systems, it has higher signal transmission reliability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of power line communication architecture according to the present disclosure.

FIG. 2 is a schematic view of a device in the power line communication architecture according to the power according to the present disclosure.

FIG. 3 is a schematic view of the power line communication architecture according to the power according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

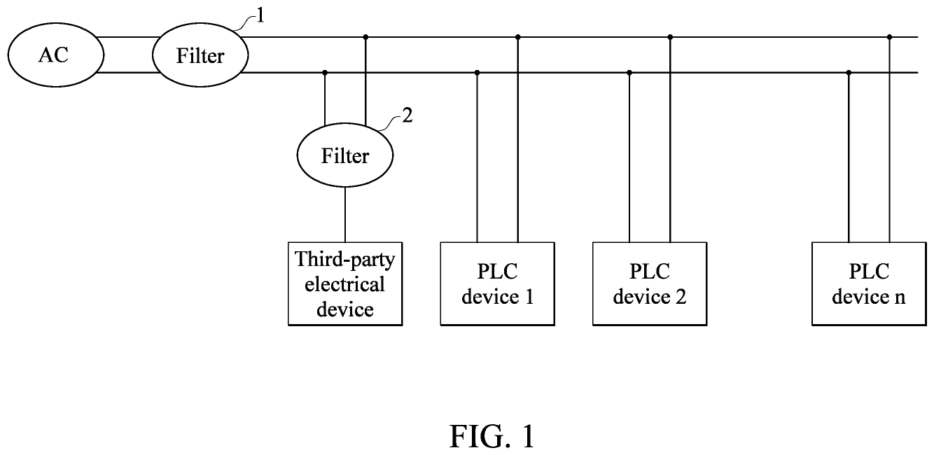

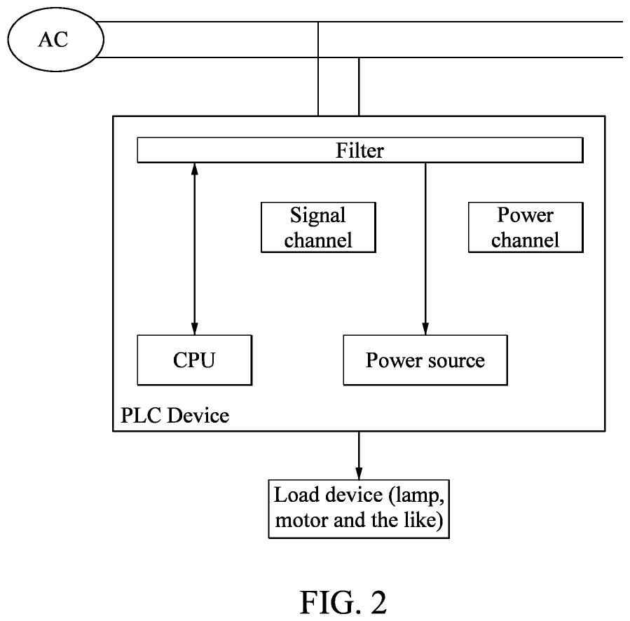

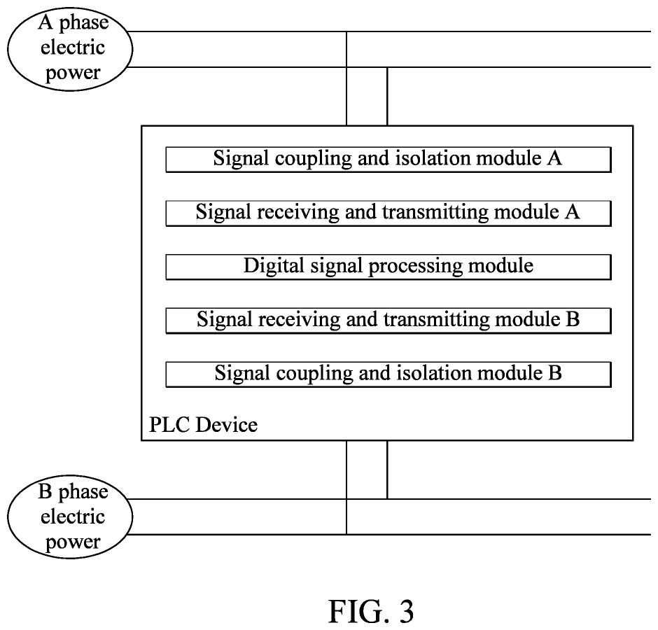

Referring to FIG. 1, power line communication architecture for indoor environment having a power cable includes: two filters (1, 2), a CPU, and a power source. The filter 1 is disposed between the power cable and an indoor circuit, and the filter 2 includes an independent sub filter and an integrated sub filter. The independent sub filter is connected in series between an external device and the indoor circuit. As shown in FIG. 2, the integrated sub filter is disposed in an original device connected to the indoor circuit in series. The integrated sub filter separates power and signals and forms a signal channel and a power channel, the signal channel provides an access for a control signal to enter and exit, and the power channel provides power for an internal power supply and a load controlling output of the original device. The power channel blocks the control signal, and the signal channel blocks power so as to prevent the control signal from being attenuated due to an overload occurred in the original device. As shown in FIG. 3, the power line communication architecture further includes two signal coupling and isolation modules (A, B), two signal receiving and transmitting modules (A, B), and a digital signal processing module. The signal coupling and isolation modules A and B are used to load the control signal into the power line or extract the control signal from the power line, and isolate alternating current; the signal receiving and transmitting modules A and B are used to digitalize an analog signal extracted from the power line by the signal coupling and isolation modules A and B, or convert a digital signal to an analog signal to be loaded into the power line by the signal coupling and isolation modules A and B; the digital signal processing module digitally processes and exchanges signals obtained from power lines for A and B phases.

Comparing with the conventional power line communication system and smart light illumination control system, with the abovementioned features the power line communication architecture of the present disclosure has advantages of convenient wiring and simple structure, without setting communication lines. Further, comparing with wireless systems, the present disclosure has higher signal transmission reliability.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power line communication architecture for indoor environment having a power cable, comprising: two filters, a CPU, and a power source;
wherein one of the filters is disposed between the power cable and an indoor circuit, and the other filter includes an independent sub filter and an integrated sub filter;
wherein the independent sub filter is connected in series between an external device and the indoor circuit, and the integrated sub filter is disposed in an original device connected to the indoor circuit in series;
wherein the integrated sub filter separates power and signals and forms a signal channel and a power channel, the signal channel provides an access for a control signal to enter and exit, and the power channel provides power for an internal power supply and a load controlling output of the original device;
wherein the power channel blocks the control signal, and the signal channel blocks power so as to prevent the control signal of a power line from being attenuated due to an overload occurred in the original device;
wherein the power line communication architecture further comprises two signal coupling and isolation modules, two signal receiving and transmitting modules, and a digital signal processing module;
wherein the signal coupling and isolation modules are used to load the control signal into the power line or extract the control signal from the power line, and isolate alternating current; the signal receiving and transmitting modules are used to digitalize an analog signal extracted from the power line by the signal coupling and isolation modules, or convert a digital signal to an analog signal to be loaded into the power line by the signal coupling and isolation modules; the digital signal processing module digitally processes and exchanges signals obtained from power lines for A and B phases.
